(19) United States
(12) Patent Application Publication
(10) Pub. No.: US 2025/0158420 A1
(43) Pub. Date: May 15, 2025

(54) Power tool ecosystem, and method to reduce the usability of a device

(71) Applicant: Hilti Aktiengesellschaft, Schaan (LI)

(72) Inventor: Muhammad Salman MALIK, Augsburg (DE)

(21) Appl. No.: 18/926,628

(22) Filed: Oct. 25, 2024

(30) Foreign Application Priority Data
Nov. 15, 2023 (EP) 23210001.6

(51) Int. Cl. H02J 7/00

(52) U.S. Cl. CPC H02J 7/00034; H02J 7/00036; H02J 7/0016; H02J 7/0047

(57) ABSTRACT

A method to reduce the usability of a target device of a power tool system for a power tool system. The power tool system includes as devices a plurality of power tools, a plurality of exchangeable battery packs and a plurality of chargers. The method includes the steps of: selecting, by using a processor, at least one isolating device from one or more devices of the power tool system, which had been plugged to the target device, using information on usage of the one or more devices; sending an isolating command to the at least one isolating device; receiving the isolating command by the at least one isolating device; and disabling or limiting the at least one isolating device in its interactions with the target device and/or disabling or limiting with the at least one isolating device an operation of the target device.

This claims priority to European Patent Application EP 23210001.6, filed on Nov. 15, 2023, and hereby incorporated by reference herein.

### FIELD OF THE INVENTION

The present invention relates to a power tool ecosystem and a method to reduce the usability of a target device of a power tool system.

### BACKGROUND OF THE INVENTION

Power tools and their accessories can get lost, misplaced or stolen. This can result in significant losses for workshops or construction companies. Current power tools are mostly cordless power tools and cordless power tool systems comprise power tool, battery, and charger. Physical protection by locking devices away is a common solution against theft, however, it is difficult to ensure a proper locking away on construction sites. Therefore, other methods and systems have been developed.

US20170364360A1 describes techniques for providing anti-theft protection for power tools by a power tool which disables itself after a predetermined amount of usage time, and re-enables usage only after secure, software-based authentication of the device.

JP2005342796A describes a rechargeable electric tool and means for transmitting a search signal in a rechargeable electric tool in which a battery pack is detachable from the electric tool body. The electric tool main body and the battery pack is provided with notification means for notifying the user in response to the search signal. Specifically, the battery pack is provided with search signal receiving means that operates using the built-in rechargeable battery as a power source and can notify a user by sound or light.

JP4678199B2 describes an authentication unit that transmits or receives information on tool usage to or from an authentication device worn by the user, and a tool usage confirmation output from the authentication unit or the authentication device that performs the authentication operation. A person who does not wear the proper authentication equipment cannot use the power tool.

U.S. Pat. No. 10,285,003B2 describes a power distribution box including a power input, an AC output, a power-line adapter, and a gateway device. The power-line adapter is coupled to the power input and configured to receive power via the power input and to communicate with an external network. The gateway device is coupled to the power-line adapter and includes a wireless network module and a translation controller. The wireless network module is configured to communicate with power tool devices in a wireless network, and the translation controller is coupled to the power-line adapter and enables communications between the wireless network module and the external network through the power-line adapter.

JP2017126560A describes a power tool system and an adapter for the power tool system to prevent theft of a handheld power tool, its battery, and its charger. Each of the handheld power tool and the battery has a passcode. Each passcode is compared, for example, when the battery is attached to the power tool or electrically connected in other ways. When the pass code of the power tool and the battery pack does not match or does not correspond in a predetermined manner, the power tool, or the battery the power tool cannot be operated. Also, a battery charger may have a pass code. The battery and charger passcodes are directly compared, for example, when a battery is attached to a charger for charging. When the pass codes of the battery and the charger do not match or do not correspond, charging of the battery is hindered.

US20140339922A1 describes a battery pack which includes an electrical energy store, a data memory, and an interface for the alternative connection of the battery pack to a data source or a data sink. The data memory is designed to store data from the data source while the interface is connected to the data source, and to supply the data in the data memory to the data sink while the interface is connected to the data sink.

### SUMMARY OF THE INVENTION

It is one object of the present invention to provide an improved power tool ecosystem and a method to reduce the usability of a target device of a power tool system, thus enabling improved controlling of the use and collaboration of the devices in the power tool ecosystem, in particular, improved or facilitated preparation of power tools, their battery packs and chargers for theft deterrence or measures after theft has happened.

The present invention provides a method to reduce the usability of a target device of a power tool system for a power tool system. The power tool system comprises as devices a plurality of power tools, a plurality of exchangeable battery packs and a plurality of chargers. The method comprises the steps of: selecting, by using a processor, at least one isolating device from one or more devices of the power tool system, which had been plugged to the target device, using information on usage of the one or more devices; sending an isolating command to the at least one isolating device; receiving the isolating command by the at least one isolating device; and disabling or limiting the at least one isolating device in its interactions with the target device and/or disabling or limiting with the at least one isolating device an operation of the target device.

Power tool systems comprise various devices. The devices include several power tools, such as saws, drivers or wrenches, rotary hammers, or drill and screw drivers, several chargers, and several battery packs, which can be plugged to and charged on the chargers, and which can be plugged exchangeably to the power tools. Sometimes devices in such a system get stolen or missing and the intention is to make such a device less useable. The possibility that a stolen device can be made less useable, makes stealing of devices less attractive and deters thieves and receivers of stolen good. Plugging includes also setting up a wireless charging or power supplying connection, e.g., via an inductive connection.

A stolen device may be not directly accessible, e.g., to deactivate the stolen device, e.g., via a mobile communication network. However, an indirect approach via devices, which had been used in the past together with the stolen device, e.g., have been plugged to the stolen device, may still be feasible. E.g., a stolen power tool may not be directly accessible, however, a stolen battery pack which is used together with the stolen power tool may be accessible via a charger connected by a mobile communication network to a backend. Disabling the battery pack by sending an isolating command from the backend to the connected charger makes the stolen battery pack less useable. Transferring a locking command, included in the isolating command, via the stolen battery pack to the stolen power tool, can disable the power tool and making it thus also less useable. To ensure an indirect access, the chargers of the power tool system may be required to connect from time to time to the backend and may disable themselves or may limit their operation, when not connected to the backend in a predefined way, e.g., at a predefined time, time period, charging time, number of charging operations and/or number of charged devices.

Devices of a power tool system work together. A power tool needs a battery pack to work, the battery pack needs a charger, thus the power tool also needs a charger. To restrict the collaboration with devices used together with a target device, makes the target device less useable. E.g., a stolen power tool, as the target device, is used together with two battery packs and two chargers. Disabling any of the two battery packs and two chargers, is an annoyance for any user of the stolen power tool and thus makes the stolen power tool less useable.

A way to find the right devices to make the stolen device less useable is necessary. E.g., disabling all battery packs of a power tool system may make a stolen power tool less useable, however, all other power tools are also rendered useless. To select the right one or more devices, the isolating devices, for making the missing or stolen or otherwise interesting device, i.e., the target device, less useful, information on usage of devices which had been plugged to the target device is used. E.g., if there are several battery packs which had been plugged to a power tool as the target device in the past, however, one of the battery packs was only plugged to the target device and not to other devices, this battery pack might be a good choice as the isolating device, and might be disabled, thus rendering the target device less useable. If several battery packs had been plugged to the target device and to other power tools in the past, however, only one battery pack has been plugged to the target device after the target device was reported, the latter battery pack might be a good choice. The selecting may comprise also a determination of the interaction of the at least one isolating device with the target device. The selecting may also comprise routing information, i.e., a way how to forward an isolating command to the isolating device.

To inform an isolating device about its selection, about its future operation or about the target device and its interaction with the target device, the isolating command is sent to the isolating device. The isolating command may be sent directly, e.g., from the backend to the connected charger, e.g., via a wireless or wired communication network, or indirect, e.g., from the backend to a battery pack via the connected charger, when the battery pack is plugged to the connected charger and, e.g., a communication line of the plugging connection is used. The isolating command may also be transferred by the battery pack from the connected charger to a power tool. A battery pack may also have a wireless communication module to receive the isolating command directly from the backend. Upon receiving the isolating command, the isolating device disables or limits its future interactions with the target device and/or disables or limits the operation of the target device, in particular, the next time when connected to the target device. The isolation command may be executed, upon receiving by the isolating device. The execution may happen fully or in parts, at the time of receiving and/or at a later time.

Depending on the target device, whether it is a power tool, a battery pack or a charger, and the selection of the at least one isolating device, whether it is a power tool, a battery pack or a charger, there are options, which may be chosen from, what disabling or limiting may mean. In embodiments disabling or limiting the interactions of the at least one isolating device with the target device or disabling or limiting with the at least one isolating device the interactions of the target device with the devices of the power tool system, when plugged to the target device, comprises alternatively or in combination:
disabling or limiting a battery pack as the at least one isolating device from supplying power to the target device, if the target device is a power tool, when plugged to it,
disabling or limiting a battery pack as the at least one isolating device from supplying power to any power tool from the plurality of power tools, when plugged to it,
disabling or limiting a charger as the at least one isolating device from charging the target device, if the target device is a battery pack, when plugged to it,
disabling or limiting a charger as the at least one isolating device from charging any battery pack from the plurality of chargers when plugged to it, 1 disabling or limiting a power tool as the at least one isolating device from getting supplied with power by the target device, if the target device is a battery pack, when plugged to it,
disabling or limiting a power tool as the at least one isolating device from getting supplied with power by any battery pack, when plugged to it,
disabling or limiting the operation of a power tool as the target device by a battery pack as the at least one isolating device, when plugged to it, and
disabling or limiting the operation of a battery pack as the target device by a charger or a power tool as the at least one isolating device, when plugged to it.

Disabling operation or disabling to supply power or to be supplied with power or to charge or to be charged is a rather strict way for the devices of the power tool system to interact with each other. This might be a way, e.g., for target devices which are known as stolen. Limiting operation or limiting to supply power or to be supplied with power, to charge or to be charged, e.g., to a predefined number of chargings or operations or a predefined level of charging, a predefined period of time or number of operations might be a way for a target device with unclear status.

In embodiments, the using information on usage of the one or more devices comprises using information comprising: a time and/or a duration when the one or more devices have been plugged to the target device, particularly, plugged to the target device in a predefined first period; a number of times the one or more devices have been plugged to the target device, particularly, plugged to the target device in a predefined second period; and/or information, particularly identifiers, on devices other than the target device, the one or more devices have been plugged to, particularly, plugged to in a predefined first period.

Different power tool systems and different devices may have different information for the selecting of the at least one isolating device available. As shown above, already the information which devices have been connected to the target device can help to select the at least one isolating device. Further information, like time, duration, numbers of combined use, shown, e.g., by the number of times devices had been plugged, may improve the selecting. Also, information on other devices, to which potential isolating devices had been plugged, is helpful.

Identifiers of devices may be used for the selecting step. Identifiers of devices of the power tool system may also be used to direct the isolating command to the right device. The devices of the power tool system may have unique identifiers, which they may communicate to other devices when plugged to each other or which they may communicate via wireless or wired connections or networks.

The information on usage may be used in various ways for the selecting. E.g., in embodiments the selecting the at least one isolating device may comprise alternatively or in combination:
selecting all of the one or more devices which had been plugged to the target device, in particular, selecting of the one or more devices, which had been plugged to the target device, all devices, which have been plugged to the target device in a predefined period,
selecting from the one or more devices, which have been plugged to the target device, one or more devices, which have been plugged only to the target device, in particular, plugged only to the target device within a predefined third period,
using for the selecting a ranking of the one or more devices which had been plugged to the target device, the ranking being based on the time, the duration, the number of times and/or the number of the devices other than the target device, and 1 using for the selecting a calculation of a likelihood for each of the one or more devices, which had been plugged to the target device, to be connected in the future to the target device.

Depending on the power tool system and the possibilities and requirements of the power tool system, the skilled person may find further adapted ways for the selecting step.

In an embodiment, the target device, for which the usability is intended to be reduced, is reported to the backend, particularly, by a first user with a first input/output system. The reported target device may be communicated from the backend to the first charger. The target device may be determined, e.g., by a backend system, e.g., based on algorithms or an artificial intelligence based determination, an input/output system, or by a user. The user might, e.g., in an asset management system, determine that a device is missing, or a physical inventory might show missing devices. The user can decide which devices he is interested in and report such devices as target device. Such a reporting can be done via an input/output system, such as a personal computer, a smart phone, or a tablet to a backend. An asset management system may be used for the reporting.

In an embodiment, after selecting the at least one isolating device, a message is sent to the first or a second input/output system with information on the at least one isolating device and the first or a second user confirms, exchanges, or rejects the selected at least one isolating device. If an automatic process for the isolating command is not desired, a human intervention may be integrated in the process. A user may confirm the selected isolating device and the process may continue. The user may also exchange the selected isolation device or completely stop the process.

There are various ways to communicate with the devices and in between the devices. A way to enable communication between the devices is by devices which can communicate when plugged to each other. In an embodiment, a first battery pack transfers to the first or a second charger, when plugged to the first or the second charger, a first battery pack identifier, first battery pack usage data, and/or information on devices, the first battery pack had been plugged to. Battery packs of the power tool system may transfer in this way their data to chargers of the power tool system. When plugging the battery packs to chargers and/or power tools, together with the electrical connection for power supply or charging, a communication connection may be established.

Using battery packs as shuttles for data, further, particularly indirect, communication between the devices of the power tool system can be enabled, and data from power tools may be transferred to the chargers.

In an embodiment, the first battery pack receives from a first device, particularly the target device, when plugged to the first device, device data, particularly, the device data comprises a first device identifier, first device usage data, and/or information on devices, the first device had been plugged to. The first battery pack stores the device data, and the first battery pack transfers the device data to the first or the second charger, when plugged to the first or the second charger.

The communication between devices plugged to each other can be used for various cases. In an embodiment, the first and/or a second battery pack receives from the first, the second or a third charger, when plugged to the first, second or the third charger, the isolating command.

In an embodiment, the first and/or the second battery pack disable or limit their interactions with the target device, when the first and/or second battery pack has been selected as the at least one isolating device. Battery packs play a central role in power tool systems, as the battery packs may be used with various chargers and power tools and the power tools require charged battery packs for operation.

In an embodiment, the first and/or the second battery pack store the isolating command and transfer the isolating command to the first or a second device, when plugged to the first or second device. Due to the central role, the battery packs may be used to communicate data and commands to devices which are not plugged to a charger, particularly not plugged to a connected charger.

In an embodiment, the first and/or a second battery pack receive from the first, the second or a third charger, when plugged to the first, second or the third charger, a command to disable or limit the first and/or a second battery pack's operation, when the first and/or the second battery is the target device and the first, second and/or third charger have been selected as isolating devices. Battery packs may also be target devices and thus disabling the operation of a, e.g., stolen, battery pack may be desired.

In an embodiment, the step of selecting is performed on the backend and the backend sends the isolating command to one or more chargers of the power tool system. When the one or more chargers have been selected as the at least one isolating device, the one or more chargers disable or limit their interactions with the target device and/or disable or limit the operation of the target device, when the target device is plugged to the one or more chargers. The one or more chargers may also further transfer the isolating command.

The isolating command may comprise information about the at least one isolating device, e.g., the identifier of the isolating device. Thus, the isolating command may be sent to a charger and the charger will forward it to a battery pack with the identifier of the isolating device. The isolating command may also comprise routing information, e.g., an identifier of a battery pack which may carry the isolating command to a power tool as the isolating device. The charger may then transfer the isolating command to the battery pack, which, when connected the next time to the power tool, may transfer the isolating command to the power tool.

In an embodiment, the step of selecting is performed on the first charger and the first charger sends the isolating command to one or more battery packs of the power tool system, which have been selected as the at least one isolating device. These one or more battery packs disable or limit their interactions with the target device and/or disable or limit the operation of the target device, when the target device is plugged to the one or more battery packs. These one or more battery packs may also further transfer the isolating command.

There may be power tool systems where, e.g., the connectivity of the chargers to a backend is problematic. In such a case the selecting may be shifted to chargers. The chargers are a necessary component of the power tool system, which generally may also work without a communication connection to a backend.

Further, the present invention provides a power tool ecosystem, which is configured to reduce the usability of a target device of a power tool system. The power tool ecosystem comprises a backend and the power tool system. The power tool system comprises a plurality of power tools, a plurality of exchangeable battery packs and a plurality of chargers as devices. A first charger of the power tool system and/or the backend is configured to select, by using a processor, at least one isolating device from one or more devices of the power tool system, which had been plugged to the target device, using information on usage of the one or more devices. The power tool ecosystem is configured to send an isolating command to the devices. The devices of the power tool system are configured to receive the isolating command. The devices of the power tool system are configured, upon receiving the isolating command, to limit their interactions with the target device. Alternatively or additionally, the devices of the power tool system are configured to limit the interactions of the target device with other devices of the power tool system, when plugged to the target device.

A power tool ecosystem may be configured to support the method to reduce the usability of a target device. Depending on the configuration, a charger of the power tool system and/or the backend is configured to select, by using a processor, at least one isolating device.

In an embodiment, the chargers are communicatively connected via a wired or a wireless connection to the backend and the backend is configured to transfer data to and receive data from the chargers and the chargers are configured to transfer data to and receive data from the backend. The chargers of the power tool system may be used to communicate to the power tool ecosystem beyond the devices of the power tool system and may act as gates for communication into the power tool system. The communication of the chargers may be implemented as a communication module of the charger.

In an embodiment, the chargers are configured to transfer to and receive data from the battery packs when the battery packs are plugged to the chargers. The battery packs are configured to transfer to and receive data from the chargers and the power tools when the battery packs are plugged to the chargers or the power tools. The power tools are configured to transfer to and receive data from the battery packs when the battery packs are plugged to the power tools. The battery packs are configured to store charger data received from the chargers and transfer the charger data to the power tools. The battery packs are further configured to store power tool data received from the power tools and transfer the power tool data to the chargers; and transfer battery pack data, created and/or stored on the battery pack, to the power tools and the chargers.

Within the power tool system, the communication may be implemented by using direct communication connections between devices plugged to each other, particularly, communication connections established together with the electrical connection for supplying power, when plugging the devices together. To transfer data from chargers to power tools, the battery packs may be used as data transfer shuttles.

In an embodiment, the charger data comprises charger, battery pack and/or power tool identifiers, information on location, and/or commands, particularly isolating commands. Various data useful for the described method to reduce the usability of a target device may be transferred from the chargers to the backend.

In an embodiment, the power tool data comprises information on usage, information on location, power tool identifiers, and/or identifiers of battery packs having been plugged to the power tools. Various data useful for the described method to reduce the usability of a target device may be transferred via battery packs to chargers.

In an embodiment, the battery pack data comprises information on usage, information on location, battery pack identifiers, and/or identifiers of power tools having been plugged to the battery packs. Various data useful for the described method to reduce the usability of a target device may be transferred from battery packs to chargers.

Further a computer program product is provided with instructions which, when the program is executed by one or more processors in the described power tool ecosystem, cause the power tool ecosystem to carry out the described method to reduce the usability of a target device.

The various embodiments of the method to reduce the usability of a target device may be combined with the use of the embodiments of the disclosed power tool ecosystem.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

### BRIEF DESCRIPTION OF THE DRAWINGS

Further embodiments, features and advantages of the present invention will become apparent from the subsequent description and dependent claims, taken in conjunction with the accompanying drawings, in which:

FIG. 1 shows in a flowchart a process flow of a method to reduce the usability of a target device;

FIG. 2 shows a schematic presentation of communication within a power tool ecosystem for a method to reduce the usability of a target device; and

FIG. 3 shows a schematic presentation of selecting isolating devices.

In the Figures, like reference numerals designate like or functionally equivalent elements, unless otherwise indicated.

### DETAILED DESCRIPTION

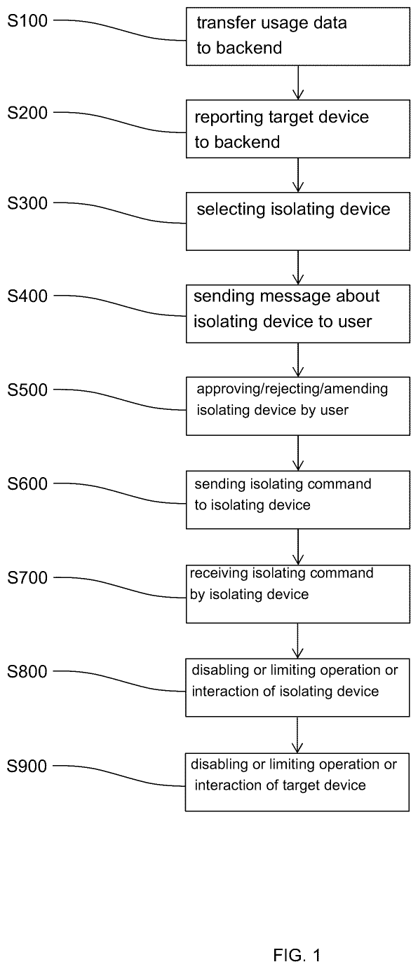

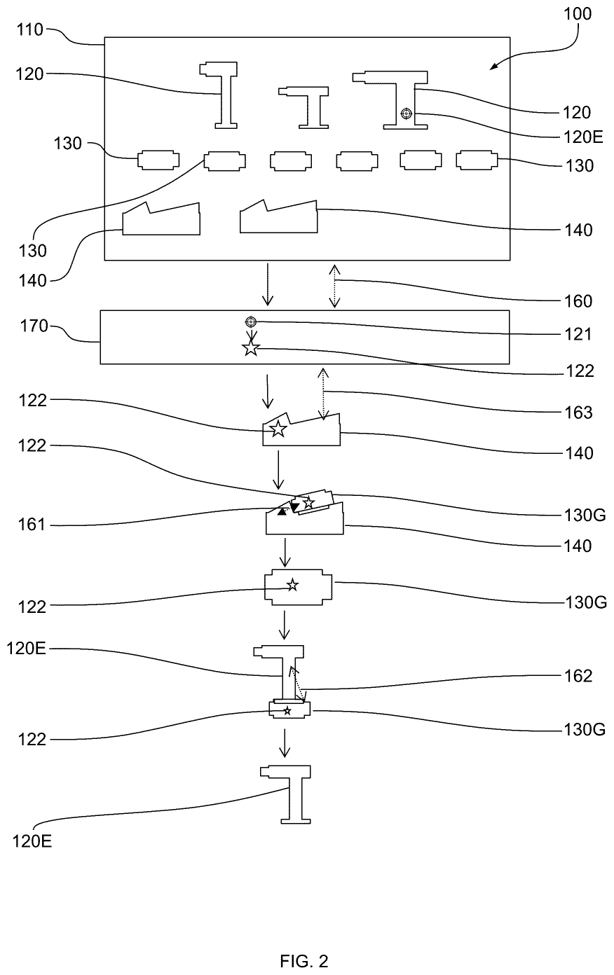

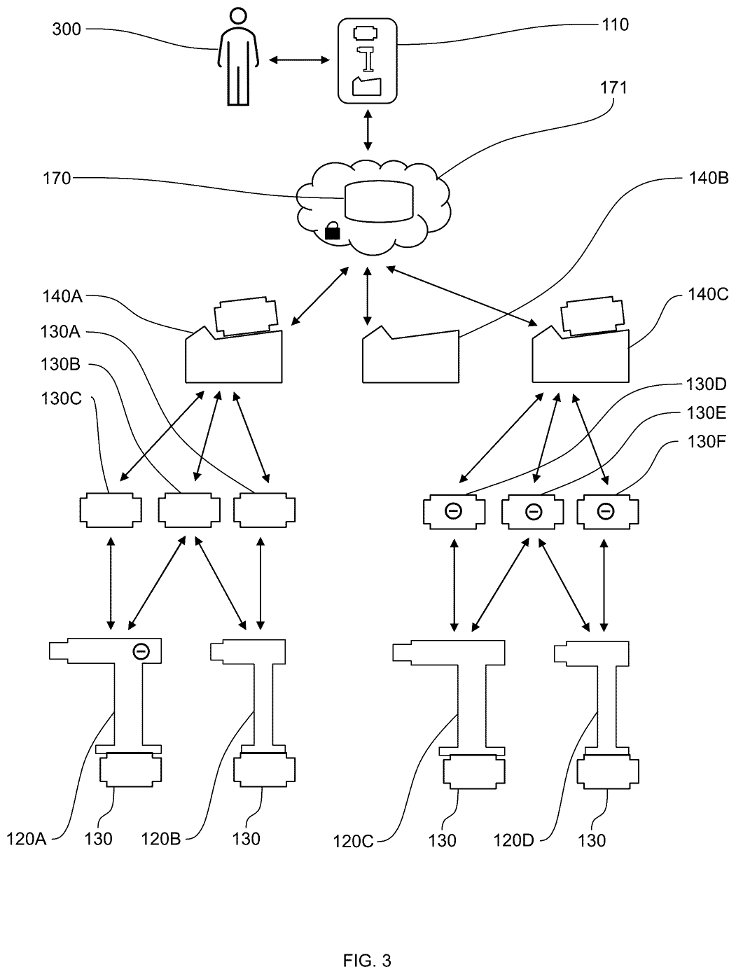

FIG. 1 shows in a flowchart a process flow of a method to reduce the usability of a target device described in relation to FIGS. 2 and 3.

In step S100, usage data from devices of a power tool system 100 is transferred to a backend 170. This may be implemented as described in more detail with regard to FIGS. 2 and 3 below. Chargers 140 transfer data, in particular their own usage data, to the backend 170, when connected to the backend 170. Chargers 140 also transfer data received from battery packs 130, when the battery packs 130 have been plugged to the chargers 140. This data may be stored on the chargers or, if a charger is connected to the backend 170 and plugged to a battery pack 130, the data may be transferred directly to the backend 170. The battery packs 130 transfer own usage data and may transfer usage data from power tools 120 they have been connected to in the past, and which has been stored in a memory of the battery packs 130. The usage data from chargers 140, battery packs 130, and/or power tools 120 is stored in the backend 170. The data may be used for an asset management system to optimize the usage of the devices of the power tool system 100.

In step S200, a user 300 is reporting a target device to the backend 170. The user 300 has seen that a power tool 120 is missing and believes that the power tool 120 has been stolen. The user 300 wants to make the power tool 120 less useable for any third person, preferably disable the power tool 120, and reports the power tool 120 as target device.

In step S300, the backend 170 evaluates the available, stored usage information. This information comprises usage information of the battery packs 130, which had been plugged to the target device, including their interaction with other devices; and the usage information of the chargers 140, which were used to charge the battery packs 130, which had been plugged to the target device. The backend 170 selects, e.g., a battery pack 130 as the isolating device, which had been frequently used with the target device in the past and which had been only rarely used with other devices. The backend 170 may use a decision matrix, a decision tree, an algorithm, and/or an artificial intelligence-based agent in the selecting step. In the selecting step S300, the way of interaction of the at least one isolating device with the target device may be determined, e.g., whether the isolating device should be disabled or limited in its interactions with the target device only, or with all devices of the power tool system 100, or whether the isolating device should disable or limit the operation of the target device, e.g., by a lock command. E.g., the battery pack 130, selected as the isolating device, should be disabled for supplying power to the target device and should disable the operation of the target device. In the selecting step S300 additionally routing information may be determined, e.g., to find a communication path to the isolating device.

In step S400, the selection of the isolating device and the way of the isolating device to interact with the target device and other devices is sent for approval to the user 300. Particularly, where isolating devices may be disabled or limited in their interaction with devices other than the target device, this might be desired by a user 300.

In step S500, the user 300 approves the results of the selecting step S300.

Alternatively, the user 300 may exchange the isolating device, e.g., based on information the user 300 has received from the backend 170, showing alternatives for the isolating device. The user 300 may also stop the process, e.g., because the user 300 has found or was informed about the target device.

In step S600, the isolating command 122, comprising information on the isolating device, the way for the isolating device to interact with the target device, information on the target device, e.g., an identifier of the target device, and/or routing information is sent. The isolating command 122 is, e.g., sent to a charger 140, which has the battery pack 130, which was selected as the isolating device, plugged to it and the charger 140 transfers the isolating command 122 to the battery pack 130. Alternatively, the isolating command 122 may be sent to several chargers 140, which had been plugged to the isolating device in the past. The several chargers 140 store the isolating command 122 and transfer the isolating command 122 to the battery pack 130, which was selected as the isolating device, when the battery pack 130 is plugged to any of the several chargers 140. The communication of the isolating command 122 within the power tool system 100 is described in more detail with regard to FIG. 2.

The isolating device receives the isolating command 122 in step S700 and, in step S800, the battery pack 130, selected as the isolating device, sets its internal settings to not supply power to a power tool 120 with the identifier of the target device.

When plugged at a later time to the target device, the isolating device communicates with the target device and receives the identifier from the target device. With the identifier received, the battery pack 130, selected as the isolating device, disables in step S900 the power tool 120, the target device, with a lock command, e.g., sent via a secure connection between the isolating device and the target device, the secure connection required to enable charging of the power tool 120. After sending the lock command, the power tool 120, the target device, stops operating and the isolating device additionally follows its settings and stops supplying power to the target device.

FIG. 2 shows a schematic presentation of communication within a power tool ecosystem for a method to reduce the usability of a target device. In an input/output (I/O) system 110, e.g., a personal computer, a tablet or a smart phone, a user 300 may choose a power tool 120, a battery pack 130 or a charger 140, as a target device. The power tool 120, the battery pack 130 and the charger 140 may have unique identifiers, which may be used to identify the physical power tool 120, battery pack 130 and charger 140. The user 300 choses a specific power tool 120 as target device 120E.

Via an I/O backend communication channel 160, the I/O system communicates information 121, particularly the identifier, about the chosen target device, power tool 120E, to a backend 170 as target device. The backend 170 may be realized as a cloud application or may be hosted on a server of the user. The backend 170 selects an isolating device, e.g., a specific battery pack 130G and sends an isolating command 122. I.e., the backend 170 provides the identifier of the isolating device and the way the isolating device should interact with the target device.

The backend 170 is connected to the chargers 140, over charger communication channels 163. The backend 170 may be connected to the chargers 140 via a secure internet connection and/or via a secure cloud 171. The connection of the chargers 140 to the backend 170 may be permanent or only from time to time. The chargers 140 may buffer data received from battery packs 130 and/or received from the backend 170.

When the isolating device, battery pack 130G, is connected to the charger 140, the charger 140 communicates with the battery pack 130 over a charger battery pack communication channel 161. The charger 140 derives from receiving the identifier of the battery pack 130G, that the battery pack 130G is the isolating device and/or is part of the routing to the isolating device. The charger 140 charges the battery pack 130G and transfers the isolating command 122 to the isolating device, battery pack 130G. The isolating command 122 is stored in the battery pack memory.

The battery pack 130G, having received the isolation command, executes as the isolating device the isolation command and changes, e.g., its internal settings, e.g., to disable supplying power to the target device, power tool 120E, for which the identifier has been communicated to the battery pack 130G as part of the isolating command 122.

The battery pack 130G can be removed from the charger 140 for usage in any power tool 120 other than the target device. When the chosen battery pack 130 is attached to the target device, power tool 120E, the power tool 120E and the battery pack 130G communicate over a battery pack power tool communication channel 162, e.g., the two devices exchange their identifiers. During this time, the battery pack 130G may supply the power tool 120E with power. The battery pack 130G receives the identifier of the power tool 120E and derives, that the power tool 120E is the target device. The battery pack 130G will stop supplying power to the power tool 120E. In the end the power tool 120E is not supplied with power from battery pack 130G and is therefore made less useable.

Similarly to the transfer of the information regarding the target device and the isolating command 122, other data and commands may be distributed in the power tool ecosystem between the power tools 120, battery packs 130, and chargers 140 and the backend 170. The communication of data may be downstream from the backend 170 or from the chargers 140 via the battery packs 130 to the power tools 120. The communication may be upstream from the power tools 120, via the battery packs 130 to the chargers 140, and, optionally, to the backend 170. There might be also sideways communication, e.g., a battery pack 130, which is plugged to a first charger 140 and later to a second charger 140, may transfer data from the first to the second charger. Similarly, a first battery pack 130 may transfer data to a power tool 120 and the power tool 120 forwards the data to a second battery pack 130, when later plugged to the second battery pack 130. Various communication paths may be realized in the power tool ecosystem. The devices may comprise memories to store data. The communication may be implemented as secured communication, e.g., using cryptographic technologies.

FIG. 3 shows a schematic presentation of selecting isolating devices. The basic flow of the method to reduce the usability of a target device of a power tool system 100 method has been described above also with regard to FIG. 1 and FIG. 2. A user 300 reports a device of a power tool system 100 as target device, e.g., because the device has been lost or stolen, a user application, e.g., of an asset management system, on an input/output system 110, e.g., a smartphone, tablet, or desktop. The information on about the target device is communicated and stored on a backend 170. The backend 170 may be implemented using a secure cloud 171.

Power tools 120, battery packs 130, and chargers 140 of the power tool system 100 store usage data when they are used with each other. E.g., when a battery pack 130 is used with different power tools 120, it can store identifiers of these power tools 120 and, e.g., how frequently it has been used with these tools, when and for how long. Similarly, a power tool 120 can also store information of battery packs 130, e.g., their identifiers, how long it is used with the battery packs 130 or, in case of multi-battery tools, with which pairs of battery packs 130 it has been used more often. Power tools 120 can transfer to and store this information in battery packs 130 plugged to the power tools 120. Plugged means, particularly, when having established an electrical connection for charging or supplying power. Similarly, chargers 140 can also store information of the battery packs 130 used with them, e.g., their identifiers, how many times they were charged on them, for how long they were charged, but also identifiers of the power tools 120 used with those battery packs 130.

When a battery pack 130 is plugged on a charger 140, the charger 140 reads out the usage data stored on the battery pack 130 and sends this data to the backend 170. The backend 170 evaluates the usage pattern of the target device by using the usage information on devices plugged in the past to a target device, e.g., a lost or stolen power tool 120, and determines isolating devices in the power tool system 100, which may be used to reduce the usability of the target device. E.g., the backend 170 may determine a battery pack 130 or a charger 140 which may be disabled to reduce the usability of the target device.

The backend 170 sends an isolating command 122, e.g., comprising a lock command for the battery back 130, which has been selected as the isolation device, to a charger 140, which transfers the isolating command 122 with the lock command to the battery pack 130. The backend 170 can also notify the user 300 that the battery 130 is likely being used with a lost or stolen tool and only trigger the isolating command 122 with the lock command when requested by user 300.

Upon receiving the isolating command 122, the isolating device, battery 130, processes the isolating command 122 and locks, i.e., stops functioning with all power tools 120 or all chargers 140 of the power tool system 100, hence also rendering the battery pack 130 useless in combination with the target tool to be used by the unauthorized persons.

Part of the usage pattern of a lost or stolen power tool 120 can also be the intensity of its usage with battery packs 130 it was plugged to, e.g., how frequently or for how long the power tool 120 has been used with the battery packs 130 over a given time interval. In the case of multi-battery tool, the usage pattern of a lost or stolen power tool 120 can also comprise a particular set of battery packs 130, that have been used with it more often than other battery packs 130, over a given time interval.

The backend 170 may, e.g., lock with the isolating command 122 battery packs 130, that were only used with a lost or stolen power tool. E.g., in FIG. 3, power tool 120A may be reported as target tool, because it is considered as lost or stolen. From usage data, the backend 170 determines that the power tool 120A has been used with battery pack 130B and 130C and locks these battery packs 130. In this case power tool 120B will also not be able to operate with battery pack 130B, which were used in the past in combination. Therefore, there may be power tool systems, which allow for a selective disabling of battery packs 130B, 130C, thus the battery packs 130B, 130C are only disabled for supplying power to the target device, power tool 120A.

The backend 170 may also lock battery packs 130 that were mostly used with the target device, using a threshold that can also be defined by a user 300. E.g., the backend 170 may lock battery packs 130 that have been used 80% of the time with the targe device. FIG. 3, e.g., power tool 120A has been reported as target device, because it is considered lost or stolen. From usage data, the backend 170 can determine that battery 130C was attached to power tool 120A for 100% of the time it has been used with any power tool 120. Battery pack 130C is then selected as the isolating device, an isolating command 122 comprising a lock command is sent to battery pack 130C and the battery pack 130C is locked.

There is only access for the backend 170 necessary to the battery packs 130, although the target device is the power tool 120A, to affect the usability of the power tool 120A. A power tool ecosystem allowing such a reduction in usability for the power tools 120, may keep thieves from stealing power tools 120 from the power tool system 100, even if there is no possibility to deactivate stolen power tools 120 themselves. There is always the threat, that the stolen power tools 120 lose their usability, because there are less or no battery packs 130 to supply power to the stolen power tools 120.

The backend 170 may also lock battery packs 130 that were used with the target device with the highest intensity. E.g., in FIG. 3 the power tool 120A is reported as the, e.g., lost or stolen, target device. From usage data, the backend 170 determines that the power tool 120A has been used with battery pack 130C for 10 hours in the last month and with battery pack 130B for only 2 hours. The backend 170 selects battery pack 130C as the isolating device, sends the isolating command 122 comprising the lock command to battery pack 130C and locks battery 130C.

The backend 170 may also implement a prioritization mechanism, e.g., disable battery packs 130 used with highest intensity with the target device first. If it is determined that the target device is still used with other battery packs 130, further battery packs 130 may be disabled.

The backend 170 may also disable battery packs 130 that were used with the target device from working with the target device but still allow the battery packs to work with other power tools 120.

The backend 170 may also lock chargers 140 by evaluating their usage with battery packs 130 that were used in combination with a target device. E.g., in FIG. 3, the charger 140A can be selected as the isolating device, as the backend 170 can determine from usage data, that battery packs 130B, 130C were charged on charger 140A and these battery packs 130B, 130C were also used with the target device power tool 120A. In this case charger 140A will also not be able to operate with battery pack 130A, which was charged in the past on the charger 140A. Alternatively, there may be power tool system, which allows for a selective disabling of chargers 140 with regard to battery packs 130, e.g., the charger 140A is only disabled for charging the battery packs 130B and 130C.

The user 300 may also report stolen or lost battery packs 130 as target device. The backend 170 may lock chargers 140 or power tools 120 by evaluating their usage with battery packs 130, that were reported as target device by the user 300. E.g., in FIG. 3, battery packs 130D, 130E, 130F are reported as target devices. From usage data, the backend 170 determines that the battery packs 130D, 130E, 130F are used with power tools 120C, 120D and with charger 140C and locks these power tools 120 and chargers 140.

There are also power tool systems 100, which allow a power tool 120 to be disabled, locked, by a battery pack 130 plugged to it. In such a case the user 300 may want to disable a lost or stolen power tool 120 as target device itself. The backend 170 evaluates the usage of battery packs 130 which had been plugged to the target device to determine battery packs 130 that are most likely to be used with the target device and can transfer a lock command to the target device to disable the target device. The backend 170 might optimize the selection based on an assessment of the shortest possible time and/or the highest probability of success. The backend 170 sends the isolating command 122 including a lock command for the target device only to these selected battery packs 130. One of these battery packs 130 may then forward the lock command to the target device, when plugged to it. On receiving the lock command, the target device stops working. E.g., in FIG. 3, the power tool 120A is reported as lost or stolen target device.

From usage data, the backend 170 determines that power tool 120A is used with battery packs 130B, 130C. The backend 170 selects the battery packs 130B, 130C as isolating devices and forward the isolating command 122 comprising a lock command for the power tool 120A to the battery packs 130B, 130C. The backend 170 may forward the isolating command 122 first to battery pack 130C as it was used with tool 120A with highest intensity and only later to battery pack 130B.

Information on target device, such as lost or stolen power tools 120 or battery packs 130 may be stored on the backend 170 together with usage data of power tools 120, battery packs 130 and chargers 140. The backend 170 may also analyze the usage data, select isolating devices, and send isolating commands 120. Transferring the data to the backend 170 may not always be feasible, e.g., sending data via cellular connectivity can be costly, chargers 140 may not always have connectivity to send and receive data, including commands, to and from the backend 170. The chargers 140 may need to buffer this data until connected to the backend 170 again.

Alternatively to the handling of data mainly on the backend 170, there is also the possibility that chargers 140 get updates on target devices from the backend 170. E.g., the chargers 140 may subscribe to updates in lists of target devices from the backend 170. These updates may be scheduled according to needs of the power tool ecosystem, e.g., once a week or when connectivity is available. The chargers 140 receive data from battery packs 130 and locally analyze usage data, select isolating devices, and send isolating commands 120, e.g., to lock power tools 120, battery packs 130, and/or chargers 140, including themselves.

A charger 140 may not be able to fully analyze the usage of devices having been plugged to the target device with information on all battery packs 130, as some battery packs 130 may not be charged on it. However, the charger 140 can analyze locally, select the isolating device locally and send the isolating command 122, including, e.g., a lock command. E.g., the charger 140 may thus lock all battery packs 130 that have been used only with the target device, lock all battery packs 130 that were used with a lost or stolen power tool 120, reported as target device, regularly over several charging cycles, or lock all battery packs 130 that have been used with lost or stolen battery packs 130, reported as target device, for more than a predefined threshold time or period.

For security reasons, isolating commands 120 and/or other communicated date may need to be secured, e.g., signed with ECDSA. In this case, chargers 140 may also act as an intermediate certificate authority (CA) to the backend 170 and sign the isolating commands 120 created by them for power tools 120, battery packs 130 or chargers 140.

A charger 140 may inform the backend 170 to alert the user 300 before sending an isolating command 122. However, by the time the user 300 confirms sending the isolating command 122, battery packs 130 may be unplugged from the charger 140, and the charger 140 will not be able to transfer the isolating command 122 to these battery packs 130. The backend 170 may store the requests by chargers 140 to send isolating commands 120 and if they are approved or not yet approved by a user 300. If they are approved and next time a charger 140 requests the user 300 to approve the isolating command 122 again, the backend 170 can immediately send this approval to the charger 140 on behalf of the user 300.

Although the present invention has been described in accordance with preferred embodiments, it is obvious for the person skilled in the art that modifications are possible in all embodiments.

### REFERENCE NUMERALS

100 power tool system
110 input/output system
120 power tool
121 information about target device
122 isolating command
130 battery pack
140 charger
160 I/O backend communication channel
161 charger battery pack communication channel
162 battery pack power tool communication channel
163 charger backend communication channel
170 backend
171 secure cloud
300 user
S100 transfer usage data to backend
S200 reporting target device to backend
S300 selecting isolating device
S400 sending message about isolating device to user
S500 approving/rejecting/amending isolating device by user
S600 sending isolating command to isolating device
S700 receiving isolating command by isolating device
S800 disabling or limiting operation or interaction of isolating device
S900 disabling or limiting operation or interaction of target device

What is claimed is:

1. A method to reduce usability of a target device of a power tool system having as devices a plurality of power tools, a plurality of exchangeable battery packs and a plurality of chargers, the method comprising the steps of:
selecting, by using a processor, at least one isolating device from one or more of the devices, which had been plugged to the target device, using information on usage of the one or more devices;
sending an isolating command to the at least one at least one isolating device;
receiving the isolating command by the at least one isolating device; and
disabling or limiting the at least one isolating device in interactions with the target device or disabling or limiting with the at least one isolating device an operation of the target device.

2. The method as recited in claim 1 wherein the disabling or limiting of the interactions of the at least one isolating device with the target device or disabling or limiting with the at least one isolating device the interactions of the target device with the devices of the power tool system, when plugged to the target device, comprises:
disabling or limiting one of the battery packs as the at least one isolating device from supplying power to the target device, if the target device is one of the power tools, when plugged to it;
disabling or limiting one of the battery packs as the at least one isolating device from supplying power to any power tool from the plurality of power tools, when plugged to it;
disabling or limiting one of the chargers as the at least one isolating device from charging the target device, if the target device is one of the battery packs, when plugged to it;
disabling or limiting one of the chargers as the at least one isolating device from charging any battery pack from the plurality of chargers when plugged to it;
disabling or limiting one of the power tools as the at least one isolating device from getting supplied with power by the target device, if the target device is one of the battery packs, when plugged to it;
disabling or limiting one of the power tools as the at least one isolating device from getting supplied with power by any battery pack, when plugged to it;
disabling or limiting the operation of one of the power tools as the target device by one of the battery packs as the at least one isolating device, when plugged to it; or
disabling or limiting the operation of one of the battery packs as the target device by one of the chargers or one of the power tools as the at least one isolating device, when plugged to it.

3. The method as recited in claim 1 wherein the using information on usage of the one or more devices comprises using information comprising:
a time or a duration when the one or more of the devices have been plugged to the target device;
a number of times the one or more of the devices have been plugged to the target device; or
information on devices other than the target device, the one or more devices have been plugged to.

4. The method as recited in claim 3 wherein one or more devices have been plugged into the target device or another device during a predetermined period of time.

5. The method as recited in claim 1 wherein the selecting the at least one isolating device comprises:
selecting all of the one or more devices which had been plugged to the target device;
selecting from the one or more devices, which have been plugged to the target device, one or more devices, which have been plugged only to the target device;
using for the selecting a ranking of the one or more devices which had been plugged to the target device, the ranking being based on the time, the duration, the number of times or the number of the devices other than the target device; or
using for the selecting a calculation of a likelihood for each of the one or more devices, which had been plugged to the target device, to be connected in the future to the target device.

6. The method as recited in claim 5 wherein one or more devices have been plugged into the target device or another device during a predetermined period of time.

7. The method as recited in claim 1 further comprising a step of reporting the target device, for which the usability is intended to be reduced, to a backend.

8. The method as recited in claim 7 wherein the reporting includes reporting the target device by a first user with a first input/output system to the backend, and, optionally, communicating the reported target device from the backend to the first charger.

9. The method as recited in claim 1 wherein after selecting the at least one isolating device a message is sent to an input/output system with information on the at least one isolating device and a user confirms, exchanges or rejects the selected at least one isolating device.

10. The method as recited in claim 1 further comprising
a first battery pack transferring to the first or a second charger, when plugged to the first or the second charger, a first battery pack identifier, first battery pack usage data, and/or information on devices, the first battery pack had been plugged to,
optionally further comprising,
the first battery pack receiving from a first device, particularly the target device, when plugged to the first device, device data, particularly, the device data comprising a first device identifier, first device usage data, and/or information on devices, the first device had been plugged to,
the first battery pack storing the device data, and
the first battery pack transferring the device data to the first or the second charger, when plugged to the first or the second charger.

11. The method as recited in claim 10 further comprising
the first or a second battery pack receiving from the first, the second or a third charger, when plugged to the first, second or the third charger, the isolating command,
optionally further comprising,
the first or the second battery pack disabling or limiting their interactions with the target device, when the first or second battery pack has been selected as the at least one isolating device, or
the first or the second battery pack storing the isolating command and transferring the isolating command to the first or a second device, when plugged to the first or second device;
or
the first or a second battery pack receiving from the first, the second or a third charger, when plugged to the first, second or the third charger, a command disabling or limiting the operation of the first or the second battery pack, when the first or the second battery pack is the target device and the first, second and/or third charger has been selected as the at least one isolating device.

12. The method as recited in claim 1 wherein the step of selecting is performed on a backend and the backend sends the isolating command to one or more of the chargers of the power tool system,
which have been selected as the at least one isolating device and disable or limit their interactions with the target device or disable or limit the operation of the target device, when the target device is plugged to the one or more chargers,
or
which further transfer the isolating command.

13. The method as recited in claim 1 wherein the step of selecting is performed on the first charger and the first charger sends the isolating command to one or more of the battery packs of the power tool system,
which have been selected as the at least one isolating device and disable or limit their interactions with the target device or disable or limit the operation of the target device, when the target device is plugged to the one or more battery packs,
or
which further transfer the isolating command.

14. A power tool ecosystem configured to reduce the usability of a target device of a power tool system, the power tool ecosystem comprising
a backend;
the power tool system including as devices:
a plurality of power tools,
a plurality of exchangeable battery packs and
a plurality of chargers,
a first charger of the plurality of chargers or the backend being configured to select, by using a processor, an at least one isolating device from one or more devices of the power tool system, which had been plugged to the target device, using information on usage of the one or more devices,
wherein,
the power tool ecosystem is configured to send an isolating command to the devices,
the devices of the power tool system are configured to receive the isolating command, and
the devices of the power tool system configured upon receiving the isolating command to limit their interactions with the target device or limit the interactions of the target device with the devices other than the target device of the power tool system, when plugged to the target device.

15. The power tool ecosystem as recited in claim 14 wherein the chargers are communicatively connected via a wired or a wireless connection to the backend and the backend is configured to transfer data to and receive data from the chargers and the chargers are configured to transfer data to and receive data from the backend.

16. The power tool ecosystem as recited in claim 14 wherein
the chargers are configured to transfer to and receive data from the battery packs, when the battery packs are plugged to the chargers,
the battery packs are configured to transfer to and receive data from the chargers and the power tools, when the battery packs are plugged to the chargers or the power tools,
the power tools are configured to transfer to and receive data from the battery packs, when the battery packs are plugged to the power tools, and
the battery packs are configured to:
store charger data received from the chargers and transfer the charger data to the power tools,
store power tool data received from the power tools and transfer the power tool data to the chargers, and
transfer battery pack data, created or stored on the battery pack, to the power tools and the chargers.

17. The power tool ecosystem according to claim 16, wherein
the charger data comprises charger, battery pack or power tool identifiers, information on location, or commands, particularly isolating commands,
the power tool data comprises information on usage, information on location, power tool identifiers, or identifiers of battery packs having been plugged to the power tools, or
the battery pack data comprises information on usage, information on location, battery pack identifiers, or identifiers of power tools having been plugged to the battery packs.

18. A computer program product comprising instructions which, when the program is executed by one or more processors in a power tool ecosystem cause the power tool ecosystem to carry out the method as recited in claim 1.
